(19) United States
(12) Patent Application Publication
(10) Pub. No.: US 2020/0148839 A1
(43) Pub. Date: May 14, 2020

(54) POLYURETHANE COMPOSITE MATERIAL AND PREPARATION METHOD THEREOF

(71) Applicant: ZHEJIANG GLORY HOME FURNISHINGS CO., LTD., Jiashan (CN)

(72) Inventors: Guohao Qiu, Jiashan (CN); Xuanhui Deng, Jiashan (CN)

(21) Appl. No.: 16/624,240

(22) PCT Filed: Mar. 13, 2019
(86) PCT No.: PCT/CN2019/077926

§ 371 Date: Dec. 18, 2019

(30) Foreign Application Priority Data
Jun. 7, 2018 (CN) 201810579715.5

(51) Int. Cl. C08J 3/22; C08J 9/00; C08J 9/12; C08G 18/48; C08G 18/38; C08G 18/61; C08G 18/50; C08G 18/66; C08G 18/76

(52) U.S. Cl. CPC C08J 3/226; C08J 9/0014; C08J 9/125; C08G 18/48; C08G 2101/0083; C08G 18/61; C08G 18/5096; C08G 18/6685; C08G 18/7671; C08G 18/3819

(57) ABSTRACT

The present invention provides a polyurethane composite material. The present invention uses coffee powder in the polyurethane material, so the obtained polyurethane composite material not only meets the requirement on mechanical property of the polyurethane material, but also has an excellent adsorption effect. Furthermore, by the use of moisture adsorption and deodorization characteristics of coffee grounds, the intrinsic chemical odor of a polyurethane product can be reduced and the polyurethane material has an aromatic odor of coffee; and the polyurethane material prepared by the invention has the strong adsorption function, and thus can remove the external odor, can make a space using the polyurethane product more fresh, and takes the environment purifying effect.

The present application claims priority to the Chinese Patent Application No. CN201810579715.5, filed with the Chinese Patent Office on Jun. 7, 2018, and entitled “POLYURETHANE COMPOSITE MATERIAL AND PREPARATION METHOD THEREOF”, which is incorporated herein by reference in its entirety.

### TECHNICAL FIELD

The present invention relates to the technical field of foam materials, and in particular to a polyurethane composite material and a preparation method thereof.

### BACKGROUND

The existing polyurethane material more or less has a certain unfriendly odor to cause a direct impact to an environment. A home appliance produced with such a polyurethane material, like a pillow and a mattress, will directly affect the sleep and living quality of a person due to the presence of the odor.

At present, a common method for deodorizing the polyurethane material includes the addition of diatomite, activated carbon or silicon dioxide in the polyurethane material. These substances can remove the odor in the polyurethane material to some extent, but when the polyurethane material added with these substances is produced, these substances have large mechanical wear to the polyurethane material to result in that the compression set of the polyurethane material becomes poor, and the prepared polyurethane material has no aromatic odor.

In addition, due to air pollution, the indoor and outdoor air is mingled with some undesirable odor possibly to directly affect a living environment of people.

Therefore, it is of great significance to develop a polyurethane composite material capable of removing the intrinsic odor released by polyurethane and the undesirable odor in a surrounding environment.

### SUMMARY

An objective of the present invention is to provide a polyurethane composite material, to remove an intrinsic odor released by polyurethane and an undesirable odor in a surrounding environment and enhance an adsorption function.

To achieve the above purpose, the present invention provides the following technical solutions.

The present invention provides a polyurethane composite material, including the following raw materials by weight:

100 parts of matrix polymer, 1-20 parts of coffee powder, 24-50 parts of isocyanate, 0.2-0.6 parts of catalyst, 0.6-1.5 parts of surfactant, 0-20 parts of foaming agent and 0.5-3 parts of cross-linking agent, wherein the matrix polymer is polyether polyol and/or polymer polyol.

Preferably, the isocyanate is toluene diisocyanate and/or modified methylenediphenyl diisocyanate.

Preferably, when the isocyanate is the toluene diisocyanate and the modified methylenediphenyl diisocyanate, the mass ratio of the toluene diisocyanate to the modified methylenediphenyl diisocyanate is 0.2-0.5:1.

Preferably, the catalyst is one or more of triethylene diamine, bis(2-dimethylaminoethyl)ether or stannous octoate.

Preferably, the particle size of the coffee powder is 50-200 meshes.

Preferably, the surfactant is a polyether-polysiloxane copolymer.

Preferably, the foaming agent is water or dichloromethane.

Preferably, the cross-linking agent is diethanolamine, triethanolamine, dipropylene glycol, butanediol or diethylene glycol.

The present invention further provides a method for preparing the above polyurethane composite material, including the following steps:

(1) mixing coffee powder with a matrix polymer to obtain a premix;

(2) mixing a catalyst, a surfactant, a foaming agent and a cross-linking agent with the premix to obtain a white material; and

(3) mixing the white material with isocyanate for foaming reaction to obtain the polyurethane composite material.

Preferably, the mixing in the step (2) is carried out under a stirring condition, and the stirring rotational speed is 500-2000 rpm.

Preferably, the temperature of the white material in the step (2) is 18-25° C., and the temperature of the isocyanate in the step (3) is 18-25° C.

Preferably, the mixing in the step (3) is carried out under the stirring condition, and the stirring rotational speed is 3000-5000 rpm.

Preferably, the temperature of the foaming reaction is 21° C. and the time is 150 s.

Preferably, the pressure of the foaming reaction is 0.1-0.2 MPa.

The present invention provides a polyurethane composite material. The present invention uses coffee powder in a polyurethane material; and by the use of moisture adsorption and deodorization characteristics of the coffee powder, the intrinsic chemical odor of the polyurethane material can be reduced and the polyurethane material has an aromatic odor of coffee, thereby making people pleasant and reducing a restless mood.

With the utilization of a large specific surface area of the coffee powder, the polyurethane material has a strong adsorption function and thus can remove the odor in a surrounding environment, makes a space using the polyurethane composite material provided by the present invention more fresh and takes an environment purifying effect. Furthermore, by using a pillow and a mattress produced with the polyurethane composite material provided by the present invention, the people are easier to get a sleep, and therefore the living quality of the people is improved.

According to an embodiment, it can be seen that the core density of the polyurethane composite material is up to 68.71 kg/m3, the indentation hardness is 60.92 N, the compression recovery rate is 97.32%, the ammonia reduction rate is 91%, the reduction rate of acetic acid is 98%, the reduction rate of isopentoic acid is 99% and the reduction rate of 2-nonenoic acid is 98%. Therefore, the polyurethane composite material provided by the present invention not only can meet the standard requirement on mechanical property, but also has an excellent adsorption function.

### BRIEF DESCRIPTION OF THE DRAWINGS

FIG. 1 is a flowchart of a process for producing a polyurethane material according to the present invention.

### DETAILED DESCRIPTION

The present invention is further described below with reference to the accompanying drawings and embodiments.

The present invention provides a polyurethane composite material, including the following raw materials by weight:

100 parts of matrix polymer, 1-20 parts of coffee powder, 24-50 parts of isocyanate, 0.2-0.6 parts of catalyst, 0.6-1.5 parts of surfactant, 0-20 parts of foaming agent and 0.5-3 parts of cross-linking agent, where the matrix polymer is polyether polyol and/or polymer polyol.

The polyurethane composite material provided by the present invention uses a matrix polymer as a matrix. In the present invention, the matrix polymer is 100 parts by weight, and the matrix polymer is polyether polyol and/or polymer polyol. In the present invention, when the matrix polymer is a mixture of the polyether polyol and the polymer polyol, a proportion between the polyether polyol and the polymer polyol is not particularly limited and may be any proportion.

Based on 100 parts of matrix polymer by weight, the polyurethane composite material provided by the present invention includes 1-20 parts of coffee powder, preferably 5-15 parts and more preferably 8-12 parts. In the present invention, the particle size of the coffee powder is 50-200 meshes, and more preferably 80-150 meshes. The source of the coffee powder is not particularly limited by the present invention and the coffee powder having the source known to a person skilled in the art may be available. Specifically, the coffee powder is, for example, the commercially-available coffee powder. By utilizing the moisture adsorption and deodorization characteristics of the coffee powder and using the coffee powder in the polyurethane composite material, the present invention can reduce the intrinsic chemical odor of the polyurethane composite material and also endows the polyurethane composite material with the adsorption property.

Based on 100 parts of matrix polymer by weight, the polyurethane composite material provided by the present invention includes 24-50 parts of isocyanate, preferably 30-45 parts and more preferably 35-40 parts. In the present invention, the isocyanate is preferably toluene diisocyanate (TDI) and/or modified methylenediphenyl diisocyanate (MDI); and the modified MDI is preferably Wanhua modified MDI 8223. In the present invention, when the isocyanate is a mixture of the TDI and the modified MDI, the mass ratio of the TDI to the modified MDI is 0.2-0.5. The present invention uses a —NCO group of the isocyanate to react with a —OH group of polyether to produce polyurethane foam.

Based on 100 parts of matrix polymer by weight, the polyurethane composite material provided by the present invention includes 0.2-0.6 parts of catalyst, and preferably 0.3-0.5 parts. In the present invention, the catalyst is preferably one or more of triethylene diamine, bis(2-dimethylaminoethyl)ether or stannous octoate.

Based on 100 parts of matrix polymer by weight, the polyurethane composite material provided by the present invention includes 0.6-1.5 parts of surfactant, preferably 0.8-1.2 parts and more preferably 0.9-1.1 parts. In the present invention, the surfactant is preferably a polyether-polysiloxane copolymer. The present invention uses the surfactant to emulsify a foam material, stabilize the foam and regulate a foam pore.

Based on 100 parts of matrix polymer by weight, the polyurethane composite material provided by the present invention includes 0-20 parts of foaming agent. In the present invention, the foaming agent is preferably water or dichloromethane; when the foaming agent is the water, the foaming agent is preferably 1.5-5.0 parts, and more preferably 2-4 parts; and when the foaming agent is the dichloromethane, the foaming agent is preferably 5-15 parts, and more preferably 8-12 parts. The present invention uses the water or the dichloromethane as the foaming agent, so that the density and hardness of the polyurethane material can be regulated.

Based on 100 parts of matrix polymer by weight, the polyurethane composite material provided by the present invention includes 0.5-3 parts of cross-linking agent, and preferably 1-2 parts. In the present invention, the cross-linking agent is preferably diethanolamine, triethanolamine, dipropylene glycol, butanediol or diethylene glycol. The present invention uses the diethanolamine, the triethanolamine, the dipropylene glycol, the butanediol or the diethylene glycol as the cross-linking agent, so that the polyurethane material can be more stable, and the hardness and tensile strength are improved.

The sources of the above raw materials are not particularly defined by the present invention, and the above raw materials having the sources known to the person skilled in the art may be available.

Specifically, the above raw materials are, for example, the commercially-available raw materials.

The present invention provides a method for preparing the polyurethane composite material in the above technical solution, which includes the following steps:

(1) Mix coffee powder with a matrix polymer to obtain a premix.

(2) Mix a catalyst, a surfactant, a foaming agent and a cross-linking agent with the premix to obtain a white material.

(3) Mix the white material with isocyanate for foaming reaction to obtain the polyurethane composite material.

According to the present invention, coffee powder is mixed with a matrix polymer to obtain a premix. The mixing is not particularly defined by the present invention, provided that a technical solution known to a person skilled in the art is adopted, and the coffee powder and the matrix polymer can be fully contacted and uniformly mixed.

After the premix is obtained, a catalyst, a surfactant, a foaming agent and a cross-linking agent are mixed with the premix to obtain a white material. In the present invention, the mixing is preferably carried out under a stirring condition, and the stirring rotational speed is preferably 500-2000 rpm, and more preferably 800-1500 rpm. In the present invention, the temperature of the white material is preferably 18-25° C.; and by controlling the temperature of the white material, the reaction may be carried out at an optimal temperature.

After the white material is obtained, the white material is mixed with isocyanate for foaming reaction to obtain the polyurethane composite material. In the present invention, the mixing is preferably carried out under the stirring condition, and the stirring rotational speed is preferably 3000-5000 rpm. In the present invention, the temperature of the isocyanate is preferably 18-25° C.; and by controlling the temperature of the isocyanate, the reaction may be carried out at the optimal temperature.

In the present invention, the temperature of the foaming reaction is preferably 21° C.; and the time is preferably 150 s. Upon the completion of the foaming reaction, a reaction product is preferably cured for 24 h. In the present invention, the pressure of the foaming reaction is preferably 0.1-0.2 MPa. In the present invention, the foaming reaction is preferably carried out in a foaming machine.

Upon the completion of the foaming reaction, the obtained foaming reaction material is cured and cut to obtain the polyurethane composite material. The curing and cutting manner of the present invention is not particularly defined, and the reaction product may be cured and cut in a manner known to the person skilled in the art.

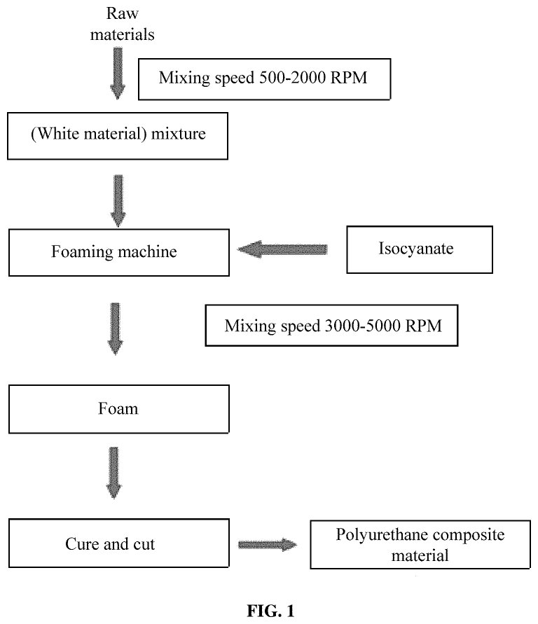

In the present invention, a flowchart of a process for producing the polyurethane composite material is as shown in FIG. 1. As can be seen from the figure, raw materials are mixed under a condition in which the mixing speed is 500-2000 rpm to obtain a white material mixture; then, isocyanate is mixed with the white material at the mixing speed of 3000-5000 rpm in a foaming machine for foaming reaction; and at last, a foaming reaction material is cured and cut to obtain the polyurethane composite material.

The polyurethane composite material and the preparation method thereof provided by the present invention are described below in detail in combination with embodiments. However, the following description cannot be understood as a limit to a protection scope of the present invention.

### Embodiment 1

5 parts of coffee powder having a particle size of 80 meshes were mixed with 100 parts of polyether polyol for 45 min to obtain a premix; 0.3 parts of triethylene diamine and bis(2-dimethylaminoethyl)ether mixture (the mass ratio of the triethylene diamine to the bis(2-dimethylaminoethyl)ether was 3:1), 1.0 part of polyether-polysiloxane copolymer (BL-818), 2.0 parts of water and 1.5 parts of triethanolamine were mixed with the premix to obtain a white material, where the stirring rotational speed in mixing was 1000 r/s; the temperature of the white material was controlled at 20° C., and the white material was mixed with MDI having a temperature of 20° C., where the stirring rotational speed in mixing was 4000 r/s; under a condition in which the foaming pressure was 0.1 MPa and the temperature was 21° C., a mixture of the white material and the MDI was subjected to foaming reaction for 150 s; and a foaming reaction product was cured for 24 h to obtain a polyurethane composite material.

### Embodiment 2

10 parts of coffee powder having a particle size of 80 meshes were mixed with 100 parts of polyether polyol for 45 min to obtain a premix; 0.3 parts of triethylene diamine and bis(2-dimethylaminoethyl)ether mixture (the mass ratio of the triethylene diamine to the bis(2-dimethylaminoethyl)ether was 3:1), 1.0 part of polyether-polysiloxane copolymer (BL-818), 2.0 parts of water and 1.5 parts of triethanolamine were mixed with the premix to obtain a white material, where the stirring rotational speed in mixing was 1000 r/s; the temperature of the white material was controlled at 20° C., and the white material was mixed with MDI having a temperature of 20° C., where the stirring rotational speed in mixing was 4000 r/s; under a condition in which the foaming pressure was 0.1 MPa and the temperature was 21° C., a mixture of the white material and the MDI was subjected to foaming reaction for 150 s; and a foaming reaction product was cured for 24 h to obtain a polyurethane composite material.

### Embodiment 3

20 parts of coffee powder having a particle size of 80 meshes were mixed with 100 parts of polyether polyol for 45 min to obtain a premix; 0.3 parts of triethylene diamine and bis(2-dimethylaminoethyl)ether mixture (the mass ratio of the triethylene diamine to the bis(2-dimethylaminoethyl)ether was 3:1), 1.0 part of polyether-polysiloxane copolymer (BL-818), 2.0 parts of water and 1.5 parts of triethanolamine were mixed with the premix to obtain a white material, where the stirring rotational speed in mixing was 1000 r/s; the temperature of the white material was controlled at 20° C., and the white material was mixed with MDI having a temperature of 20° C., where the stirring rotational speed in mixing was 4000 r/s; under a condition in which the foaming pressure was 0.1 MPa and the temperature was 21° C., a mixture of the white material and the MDI was subjected to foaming reaction for 150 s; and a foaming reaction product was cured for 24 h to obtain a polyurethane composite material.

### Comparative Example 1

100 parts of polyether polyol were mixed with 0.3 parts of triethylene diamine and bis(2-dimethylaminoethyl)ether mixture (the mass ratio of the triethylene diamine to the bis(2-dimethylaminoethyl)ether was 3:1), 1.0 part of surfactant, 2.0 parts of water and 1.5 parts of triethanolamine obtain a white material, where the stirring rotational speed in mixing was 1000 r/s; the temperature of the white material was controlled at 20° C., and the white material was mixed with MDI having a temperature of 20° C., where the stirring rotational speed in mixing was 4000 r/s; under a condition in which the foaming pressure was 0.1 MPa and the temperature was 21° C., a mixture of the white material and the MDI was subjected to foaming reaction for 150 s; and a foaming reaction product was cured for 24 h to obtain a polyurethane composite material.

Pursuant to the Cellular Plastics and Rubbers-Determination of Apparent (Bulk) Density (GB/T 6343-1995), Flexible Cellular Polymeric Materials-Determination of Hardness (Indentation Technique) (GB/T 10807-2006), Flexible Cellular Polymeric Materials-Determination of Compression Set (GB/T 6669-2008) and SEK Authentication Standard for Fiber Products, by testing the polyurethane composite materials prepared in the embodiments 1-3 in density, hardness, compression set and deodorization property, the performance test results are as shown in table 1:

TABLE 1
Performance test results of polyurethane composite materials
prepared in embodiments 1-3 and comparative example 1.

| | Standard | Embodiment | Embodiment | Embodiment | Comparative |
|---|---|---|---|---|---|
| | requirement | 1 | 2 | 3 | example 1 |
| Core density | >40 | 63.76 | 65.10 | 68.71 | 61.75 |
| (kg/m³) | | | | | |
| Indentation | >40 | 44.33 | 47.58 | 60.92 | 42.53 |
| hardness (N) | | | | | |
| Compression | >95 | 97.64 | 97.56 | 97.32 | 97.89 |
| recovery rate | | | | | |
| (%) | | | | | |
| Ammonia | >80 | 81 | 87 | 91 | 65 |
| reduction rate | | | | | |
| (%) | | | | | |
| Reduction rate of | >70 | 99 | 99 | 98 | 67 |
| acetic acid (%) | | | | | |
| Reduction rate of | >95 | 97 | >99 | 99 | 87 |
| isopentoic acid | | | | | |
| (%) | | | | | |
| Reduction rate of | >90 | 96 | 98 | 98 | 84 |
| 2-nonenoic acid | | | | | |
| (%) | | | | | |

As can be seen from table 1, the polyurethane composite material prepared by the present invention not only can meet the requirement on mechanical property of the polyurethane material, but also has an excellent adsorption function.

As can be seen from the above embodiments, the present invention provides a polyurethane composite material. The present invention uses coffee powder in a polyurethane material; and by the use of moisture adsorption and deodorization characteristics of coffee grounds, the intrinsic chemical odor of a polyurethane product can be reduced and the polyurethane material has an aromatic odor of coffee. The polyurethane material prepared by the present invention has a strong adsorption function and thus can remove the external odor, can make a space using the polyurethane product become fresher and takes an environment purifying effect.

The above description of the embodiment is only for helping to understand the method of the present invention and its core idea. It should be noted that, several improvements and modifications may be made by persons of ordinary skill in the art without departing from the principle of the present invention, and these improvements and modifications should also be considered within the protection scope of the present invention. Various modifications to these embodiments are readily apparent to persons skilled in the art, and the generic principles defined herein may be practiced in other embodiments without departing from the spirit or scope of the invention. Thus, the present invention is not limited to the embodiments shown herein but falls within the widest scope consistent with the principles and novel features disclosed herein.

1. A polyurethane composite material, comprising the following raw materials by weight:
100 parts of matrix polymer, 1-20 parts of coffee powder, 24-50 parts of isocyanate, 0.2-0.6 parts of catalyst, 0.6-1.5 parts of surfactant, 0-20 parts of foaming agent and 0.5-3 parts of cross-linking agent, wherein the matrix polymer is polyether polyol and/or polymer polyol.

2. The polyurethane composite material according to claim 1, wherein the isocyanate is toluene diisocyanate and/or modified methylenediphenyl diisocyanate.

3. The polyurethane composite material according to claim 2, wherein when the isocyanate is the toluene diisocyanate and the modified methylenediphenyl diisocyanate, the mass ratio of the toluene diisocyanate to the modified methylenediphenyl diisocyanate is 0.2-0.5:1.

4. The polyurethane composite material according to claim 1, wherein the catalyst is one or more of triethylene diamine, bis(2-dimethylaminoethyl)ether or stannous octoate.

5. The polyurethane composite material according to claim 1, wherein the particle size of the coffee powder is 50-200 meshes.

6. The polyurethane composite material according to claim 1, wherein the surfactant is a polyether-polysiloxane copolymer.

7. The polyurethane composite material according to claim 1, wherein the foaming agent is water or dichloromethane.

8. The polyurethane composite material according to claim 1, wherein the cross-linking agent is diethanolamine, triethanolamine, dipropylene glycol, butanediol or diethylene glycol.

9. A method for preparing the polyurethane composite material according to claim 1, comprising the following steps:
(1) mixing coffee powder with a matrix polymer to obtain a premix;
(2) mixing a catalyst, a surfactant, a foaming agent and a cross-linking agent with the premix to obtain a white material; and
(3) mixing the white material with isocyanate for foaming reaction to obtain the polyurethane composite material.

10. (canceled)

11. (canceled)

12. (canceled)

13. (canceled)

14. (canceled)

15. A method for preparing the polyurethane composite material according to claim 2, comprising the following steps:
(1) mixing coffee powder with a matrix polymer to obtain a premix;
(2) mixing a catalyst, a surfactant, a foaming agent and a cross-linking agent with the premix to obtain a white material; and
(3) mixing the white material with isocyanate for foaming reaction to obtain the polyurethane composite material.

16. A method for preparing the polyurethane composite material according to claim 4, comprising the following steps:
(1) mixing coffee powder with a matrix polymer to obtain a premix;
(2) mixing a catalyst, a surfactant, a foaming agent and a cross-linking agent with the premix to obtain a white material; and
(3) mixing the white material with isocyanate for foaming reaction to obtain the polyurethane composite material.

17. A method for preparing the polyurethane composite material according to claim 5, comprising the following steps:
(1) mixing coffee powder with a matrix polymer to obtain a premix;
(2) mixing a catalyst, a surfactant, a foaming agent and a cross-linking agent with the premix to obtain a white material; and
(3) mixing the white material with isocyanate for foaming reaction to obtain the polyurethane composite material.

18. A method for preparing the polyurethane composite material according to claim 6, comprising the following steps:
(1) mixing coffee powder with a matrix polymer to obtain a premix;
(2) mixing a catalyst, a surfactant, a foaming agent and a cross-linking agent with the premix to obtain a white material; and
(3) mixing the white material with isocyanate for foaming reaction to obtain the polyurethane composite material.

19. A method for preparing the polyurethane composite material according to claim 7, comprising the following steps:
(1) mixing coffee powder with a matrix polymer to obtain a premix;
(2) mixing a catalyst, a surfactant, a foaming agent and a cross-linking agent with the premix to obtain a white material; and
(3) mixing the white material with isocyanate for foaming reaction to obtain the polyurethane composite material.

20. A method for preparing the polyurethane composite material according to claim 8, comprising the following steps:
(1) mixing coffee powder with a matrix polymer to obtain a premix;
(2) mixing a catalyst, a surfactant, a foaming agent and a cross-linking agent with the premix to obtain a white material; and
(3) mixing the white material with isocyanate for foaming reaction to obtain the polyurethane composite material.

21. The preparation method according to claim 9, wherein the mixing in the step (2) is carried out under a stirring condition, and the stirring rotational speed is 500-2000 rpm.

22. The preparation method according to claim 9, wherein the temperature of the white material in the step (2) is 18-25° C., and the temperature of the isocyanate in the step (3) is 18-25° C.

23. The preparation method according to claim 9, wherein the mixing in the step (3) is carried out under the stirring condition, and the stirring rotational speed is 3000-5000 rpm.

24. The preparation method according to claim 9, wherein the temperature of the foaming reaction is 21° C. and the time is 150 s.

25. The preparation method according to claim 9, wherein the pressure of the foaming reaction is 0.1-0.2 MPa.
